(19) United States
(12) Patent Application Publication
(10) Pub. No.: US 2008/0000145 A1
(43) Pub. Date: Jan. 3, 2008

(54) ANIMAL TRAP REMOVER

(76) Inventor: Marc Weinberger, East Rockaway, NY (US)

Correspondence Address: RICHARD D. FUERLE, 1711 W. RIVER RD., GRAND ISLAND, NY, 14072, US

(21) Appl. No.: 11/309,084

(22) Filed: Jun. 18, 2006

(51) Int. Cl. A01M 23/00; A01M 23/30

(52) U.S. Cl. 43/96; 43/81

(57) ABSTRACT

An animal trap remover holds and picks up a trap that contains a dead animal. The trap remover has a trap holder with a handle on it. The trap holder has a flat base that slides underneath the trap, two opposing sides that extend upward from the flat base, and flanges at the top of the two sides, with an opening between them. The handle is higher than the flat base.

### BACKGROUND OF THE INVENTION

This invention relates to an animal trap remover for holding and removing animal traps that contain trapped animals. In particular, it is related to an animal trap remover for a spring-loaded trap containing a dead rodent.

The most commonly used and effective trap for small mammals, especially rodents such as mice and rats, is a spring-loaded trap mounted on a board. These traps are baited with cheese or other foods and are placed around a home, barn, other building, or even outside. Once an animal is caught in the trap, it is necessary to remove the trap from its location and dispose of it. The trap is inexpensive; most people do not re-use it, but simply dispose of the entire trap with the dead animal in it.

Some people may be squeamish about picking up a trap that holds a dead animal. The trap may be dirty from being on the floor and the animal's blood may be on it or the animal's body may be disfigured by the trap, which can make touching the trap an unpleasant experience.

### SUMMARY OF THE INVENTION

It is an object of the present invention to provide an animal trap remover that can be used to hold or pick up a trap having a dead animal in it.

The above objects can be attained by an apparatus that includes (a) a trap holder having (b) a flat base having two opposing sides; (c) a pair of guides at each of said two sides to receive and guide the trap into the trap holder; and (d) a handle above said flat base attached to said trap holder.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is an isometric view of a certain presently preferred embodiment of an animal trap remover according to this invention, holding a mouse trap.

FIG. 2 is a side view of the animal trap remover shown in FIG. 1.

FIG. 3 is a bottom view of the animal trap remover shown in FIG. 1.

FIG. 4 is an isometric view of the animal trap remover shown in FIG. 1, holding a cardboard information panel.

FIG. 5 is an isometric view of a further embodiment of an animal trap remover utilizing straight hollow guides.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

In a first embodiment of operating the inventive concept, an animal trap (such as a spring loaded mouse trap) can be inserted by an operator into an animal trap remover. The animal trap remover (with the trap inside) can then be placed in a location whereupon the animal (e.g. a mouse) will spring the trap. Once the trap has been sprung, the operator can then lift the animal trap remover (with the trap inside) using a handle attached to the trap remover, walk over to a trash disposal, and discard the trap into the disposal (by turning the trap remover such that the trap will fall out due to gravity) without touching the trap (or even getting to close to it) while retaining the trap remover for another use. Alternatively, the trap remover can be disposable and can be disposed of with the trap by throwing the remover with the trap inside directly into the waste disposal.

In a second embodiment of operating the inventive concept, an animal trap remover can be used to easily grab onto, lift, and remove a trap that already has a dead animal in it. The animal trap remover can typically enable a person to do this without physically touching the trap. In this embodiment, the trap is set as conventionally done, and once the trap is sprung, then the trap remover is used to hold, lift, and carry the trap to a disposal, and discard the trap into the disposal (by turning the trap remover such that the trap will fall out due to gravity). Alternatively, the trap remover can be disposable and can be disposed of with the trap by throwing the remover with the trap inside directly into the waste disposal.

An animal trap remover has a handle and a trap holder which holds the animal trap. The end of the trap holder is wedge-shaped so that it can be pushed under the end of the trap that is opposite the dead animal in order to pick up the trap. The trap can be disposed of by letting the trap slip out-of the trap holder into the garbage.

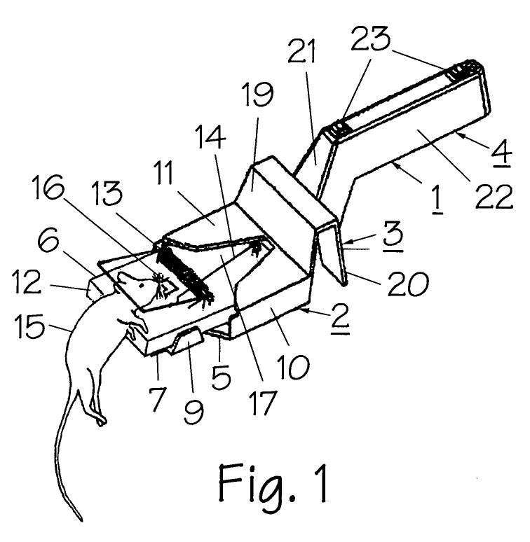

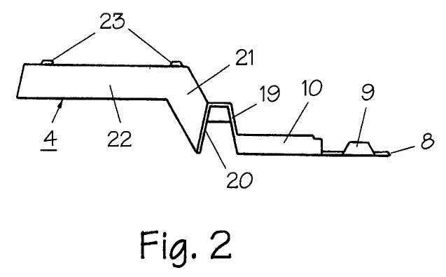

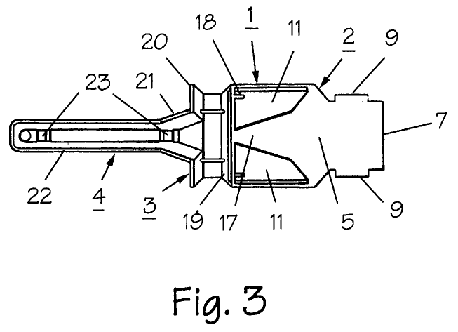

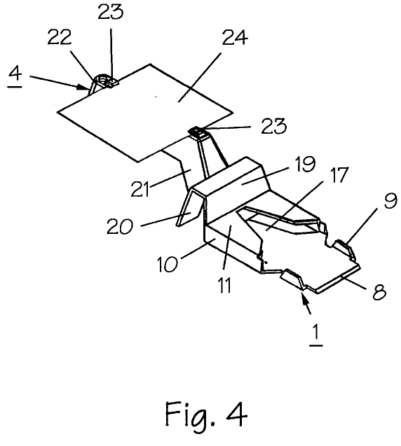

Referring now to FIGS. 1-4, an animal trap remover 1 may be made to hold and pick up a variety of different types of animal traps, and its dimensions will depend upon the size of the particular trap it is to be used to with. It is especially useful for holding and picking up spring-loaded traps, where an animal disturbing bait held by the trap releases a spring that causes a bar to clamp down upon the animal, killing it. Such traps are used for rodents, such as mice and rats. It may also be used to pick up other types of animal traps. A typical spring-loaded mouse trap is about 1⅞ inches wide and about 4 inches long and a typical rat trap is about 3¼ inches wide and about 6⅞ inches long and animal trap remover 1 may be made in two sizes to accommodate both mouse and rat traps. For a spring-loaded mouse trap, base 5 may be about 3 to about 5 inches long and about 2 inches in between guides 9 (or sides 10 if guides 9 are not present), and flanges 11 may be about ¼ to about ½ inch above the top of base 5. For a spring-loaded rat trap, base 5 may be about 5½ inches to about 8½ inches long and about 3⅜ inches in between guides 9 (or sides 10 if guides 9 are not present), and flanges 11 may be about ½ inch to about 1 inch above the top of base 5.

In the drawings, animal trap remover 1 has a trap holder 2, which is attached to bridge 3, which is in turn attached to handle 4.

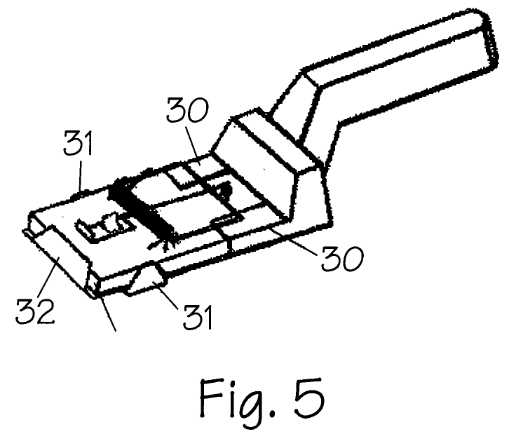

Holder 2 has a base 5 that supports animal trap 6. End 7 of base 5 has wedged-shaped bevel 8 so that base 5.will easily slide under an animal trap. Base 5 is provided with two optional guides 9, one on either side, to keep animal trap 6 aligned and prevent it from falling out of holder 2. Sides 10 are high enough to accommodate animal trap 6. Inwardly-extending horizontal flanges 11 at the top of sides 10 further secure animal trap 6 in holder 2. Spring-loaded animal trap 6 has flat board 12 to which is mounted spring 13 and spring trip lock 14. Spring 13 is released by spring trip lock 14 when mouse 15 contacts bait 16. An opening 17 between flanges 11 allows room for spring trip lock 14 of animal trap 6, so that spring trip lock 14 fits between flanges 11; flanges 11 fit between board 12 and spring 13. At the back of trap holder 2 are two optional tabs 18 that can optionally be attached to bridge 3 and/or the base 5 and/or the flanges 11, and can help to align trap 6 on base 5. An optional front rail (see FIG. 5) can be located on a front end of the base 5.

Bridge 3 has two joined surfaces 19 and 20 that cross the length of animal trap remover 1 so that holder 2 can be securely attached to surface 19 and handle 4 to surface 20.

Handle 4 has front portion 21 that extends at an angle from bridge 3 so that back portion 22 is above the bottom of base 5, thereby enabling a person to grasp back portion 22 without touching the floor or the ground on which base 5 rests. Back portion 22 is provided with two raised slots 23, which may be used to attach cardboard information panel 24, which provides information about animal trap remover 1.

Animal trap remover 1 may be constructed of plastic, metals, cardboard, paper mulch or other materials, but it is preferably made of plastic as that material is inexpensive and animal trap remover 1 can be made as a single piece by injection molding. The preferred plastics are Polyethylene Terephthalate (PET), High Density Polyethylene (HDPE), Polyvinyl Chloride (PVC), Low Density Polyethylene (LDPE), Polypropylene (PP), Polystyrene (PS), but other plastics may also be used.

To use animal trap remover 1, a baited animal trap is inserted into holder 2, the trap is set, and the trap remover and trap are placed in a location frequented by the animal to be trapped. When the animal springs the trap and is caught, animal trap remover 1 is picked up by back portion 22 of handle 4, along with the trap and the dead animal, and the trap and dead animal are dropped into the garbage or otherwise disposed of. The animal trap remover may also be reused by tilting or turning holder 2 upside down to cause the trap to fall into the garbage. Alternatively, a trap may be baited and set and picked up using animal trap remover 1 after an animal has been trapped by pushing bevel 8 of base 5 against the end of the trap that is opposite the trapped animal, thereby forcing the trap into holder 2.

FIG. 5 is. an isometric view of a further embodiment of an animal trap remover utilizing straight hollow guides.

A pair of hollow guides 30 are used to receive the trap. A pair of vertical tabs 31 are used to align the trap inside the holder. An optional front rail 32 is located on a front end 33 of the base and can be used in the embodiment of the invention wherein the trap is inserted into the trap remover before the animal springs the trap (first embodiment above).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling with the scope of the invention.

What is claimed is:

1-20. (canceled)

21. An animal trap remover for holding and picking up a trap that contains a dead animal, the trap remover comprising
(A) a trap holder having
(1) a flat base having two opposing sides; and
(2) a pair of guides at each of said two sides to receive and guide the trap into the trap holder; and
(B) a handle above said flat base attached to said trap holder.

22. An animal trap remover according to claim 21, wherein the guides comprise a pair of inwardly-extending horizontal flanges at a top of each of said two sides, where a distance from a top of said flat base to a bottom of said flanges is greater than a thickness of said trap.

23. An animal trap remover according to claim 21, wherein the guides comprise a pair of hollow guides to receive a first end of the trap, the hollow guides located at a rear of the base towards the handle.

24. An animal trap remover according to claim 21, wherein the guides comprise a vertical tab on each side to prevent the trap from sliding off the opposing sides.

25. An animal trap remover according to claim 21, further comprising an animal trap inside the animal trap remover.

26. An animal trap remover according to claim 21 wherein said trap has a flat board to which is mounted a spring trip lock and a spring released by said spring trip lock, where said spring trip lock fits between said flanges and said flanges fit between said flat board and said spring.

27. An animal trap remover according to claim 21 further comprising a front rail on a front end of the flat base.

28. An animal trap remover according to claim 27 wherein an upwardly-extending guide is mounted at each side of said flat base, whereby when a trap is inserted into said trap holder, said two guides keep said trap centered on said flat base.

29. An animal trap remover according to claim 28 wherein said trap is a spring-loaded mouse trap and the distance between said two guides is about 2 inches.

30. An animal trap remover according to claim 21 wherein said trap is a spring-loaded rat trap and the distance from said base to said flanges is about ¾ of an inch.

31. An animal trap remover according to claim 21 wherein the end of said base has a wedged-shaped bevel, whereby said base easily slides underneath said trap.

32. An animal trap remover according to claim 21 wherein said handle has two raised slots on top that hold a piece of cardboard that gives information about said animal trap remover.

33. An animal trap remover according to claim 21 wherein said animal trap is a spring-loaded mouse trap with a mouse inside of the mouse trap.

34. An animal trap remover for holding and picking up a spring-loaded rodent trap that holds a trapped dead rodent comprising
(A) a trap holder having
(1) a flat base;
(2) two opposing sides a distance apart that is greater than the width of said trap and that extend upward from opposing sides of said flat base a distance at least as great as the thickness of said trap;
(3) an inwardly-extending horizontal flange at the top of each of said two sides, where the distance between the top of said flat base and the bottom of said flanges is greater than the thickness of said trap; and
(4) and an opening between said flanges; and
(B) a handle attached to said holder and raised above said flat base.

35. An animal trap remover according to claim 34, further comprising a spring-loaded mouse trap inside said trap holder.

36. A method of removing a trap containing a dead animal without personally contacting said trap or said dead animal comprising
(A) providing
(1) a trap holder comprising a flat base having two opposing sides;
(2) a pair of guides at each of said two sides to receive and guide the trap into the trap holder; and
(3) a handle above said flat base attached to said trap holder;
(B) clasping the handle;
(C) inserting said base under the end of said trap opposite to said dead animal; and
(D) picking up said trap with said animal trap remover.

37. A method as recited in claim 36, wherein said trap is a spring loaded trap.

38. A method of removing a trap containing a dead animal without personally contacting said trap or said dead animal comprising
(A) providing
(1) a trap holder comprising a flat base having two opposing sides;
(2) a pair of guides at each of said two sides to receive and guide the trap into the trap holder; and
(3) a handle above said flat base attached to said trap holder;
(B) inserting the trap into the trap holder;
(C) setting the trap and placing the trap holder with the trap inside on a flat surface;
(D) waiting for an animal to spring the trap; and
(E) picking up said trap holder using the handle.

39. A method as recited in claim 38 wherein said trap holder further comprises a front rail on a front end of the flat base.

40. A method as recited in claim 38 wherein said trap is a spring loaded trap.
